(19) United States
(12) Patent Application Publication
(10) Pub. No.: US 2025/0141940 A1
(43) Pub. Date: May 1, 2025

(54) IN-LINE TRAFFIC SANITIZATION DEVICE AND METHOD FOR CONFIGURING SAME

(71) Applicant: GENETEC INC., Saint-Laurent (CA)

(72) Inventors: Pierre Racz, Montreal (CA); Julien Vary, Montreal (CA)

(73) Assignee: GENETEC INC., Saint-Laurent (CA)

(21) Appl. No.: 18/926,877

(22) Filed: Oct. 25, 2024

Related U.S. Application Data
(60) Provisional application No. 63/546,109, filed on Oct. 27, 2023.

(51) Int. Cl. H04L 65/1069

(52) U.S. Cl. CPC H04L 65/1069

(57) ABSTRACT

A method and system for operating a traffic sanitization device connectable intermediate an end device and a data network communicatively coupled to a server. The method comprises acquiring configuration parameters of the end device required for communicating with the server The method also comprises creating a network stack for communication with the server, the network stack including the acquired configuration parameters of the end device. The method further comprises establishing a secure communication link with the server over the data network. Also, the method comprises implementing traffic sanitization on packets received from the end device, wherein packets that have been sanitized are sent to the server over the secure communication link using the created network stack. Also, a method and system for operating the server is provided.

### CROSS-REFERENCES TO RELATED APPLICATION

The present application claims the benefit of U.S. Provisional Application Ser. No. 63/546,109, filed on Oct. 27, 2023, hereby incorporated by reference herein.

### FIELD

The present document relates generally to network communication and, in particular, to sanitization of data from an untrusted device.

### BACKGROUND

A sanitization device can be used to block potentially malicious packets coming into a data network from a non-secure end device (such as a non-secure camera). An example of a sanitization device is described in U.S. Pat. No. 10,957,170, hereby incorporated by reference herein. Configuration of a new camera or other end device with the sanitization device in place ensures that a data network remains protected from malicious packets, even if the end device is untrustworthy.

However, if the camera or other end device is already configured on the data network before a sanitization device is installed, in-line insertion of a sanitization device may disrupt the network addressing schema that will have been established for the camera or other end device. As a result, the data network may refuse packets transmitted by the sanitization device that carry data from the camera or other end device because such packets do not carry the address of the camera or other end device but rather carry an address of the sanitization device, which is an unrecognized device. Conversely, the data network will be unable to properly route commands from the server destined for the camera or other end device, again because the sanitization device is an unrecognized device.

To solve this problem, the camera or other end device needs to be reconfigured on the network with the sanitization device in place, which could result in the camera or other end device being assigned a new IP address and other parameters. As a result, multiple sets of parameters (e.g., IP addresses) could end up being assigned the same end device at different points in time. This in turn leads to disadvantages, such as adding complexity to the process used by the server to audit communications on the network.

### SUMMARY

According to a first broad aspect, there is provided a method for operating a traffic sanitization device connectable intermediate an end device and a data network communicatively coupled to a server, the method comprising: acquiring configuration parameters of the end device required for communicating with the server; creating a network stack for communication with the server, the network stack including the acquired configuration parameters of the end device; establishing a secure communication link with the server over the data network; and implementing traffic sanitization on packets received from the end device, wherein packets that have been sanitized are sent to the server over the secure communication link using the created network stack.

According to another broad aspect, there is provided a traffic sanitization device connectable intermediate an end device and a data network communicatively coupled to a server. The device comprises a memory storing computer-readable instructions and a processor configured to read the instructions in the memory so as to carry out a method that comprises: acquiring configuration parameters of the end device required for communicating with the server; creating a network stack for communication with the server, the network stack including the acquired configuration parameters of the end device; establishing a secure communication link with the server over the data network; and implementing traffic sanitization on packets received from the end device, wherein packets that have been sanitized are sent to the server over the secure communication link using the created network stack.

According to a further broad aspect, there is provided a method for operating a server connectable over a data network to an end device configured to have a set of device configuration parameters, the method comprising: receiving over the data network a message from an intermediate device connected intermediate the server and the end device; establishing a secure communication link with the intermediate device; an communicating with the end device through the intermediate device over the secure communication link using a network stack that includes at least some of the device configuration parameters.

According to a further broad aspect, there is provided a server connectable over a data network to an end device configured to have a set of device configuration parameters, the server comprising: a memory storing computer-readable instructions; and a processor configured to read the instructions in the memory so as to carry out a method that comprises: receiving over the data network a message from an intermediate device connected intermediate the server and the end device; establishing a secure communication link with the intermediate device; and communicating with the end device through the intermediate device over the secure communication link using a network stack that includes at least some of the device configuration parameters.

### BRIEF DESCRIPTION OF THE DRAWINGS

Reference will now be made, by way of example, to the accompanying drawings which show example embodiments of the present application, and in which:

FIGS. 1A and 1B are block diagrams of a network architecture without and with a traffic sanitization device intermediate a camera and a server, in accordance with a non-limiting example embodiment.

FIG. 2 is an internal block diagram showing components of the traffic sanitization device, in accordance with a non-limiting example embodiment.

FIG. 3 is a flowchart illustrating steps in a configuration process carried out by the traffic sanitization device, in accordance with a non-limiting example embodiment.

FIG. 4 is a traffic flow diagram illustrating steps in establishing a secure communication link between the traffic sanitization device and the server, in accordance with a non-limiting example embodiment.

FIG. 5 is an internal block diagram showing components of the server, in accordance with a non-limiting example embodiment.

FIG. 6 is a flowchart illustrating steps in a communication method carried out by the server, in accordance with a non-limiting example embodiment.

FIG. 7 illustrates a screen display of a graphical user interface of the server, in accordance with a non-limiting example embodiment.

FIGS. 8A and 8B are block diagrams of a network architecture without and with a traffic sanitization device intermediate a plurality of cameras and a server, in accordance with a non-limiting example embodiment.

FIG. 9 is a flowchart illustrating steps in a configuration process carried out by the traffic sanitization device in a multi-camera scenario, in accordance with a non-limiting example embodiment.

Similar reference numerals may be used in different figures to denote similar components. In the drawings, embodiments are illustrated by way of example. It is to be expressly understood that the description and drawings are only for purposes of illustrating certain embodiments and are an aid for understanding. They are not intended to be a definition of the limits of the invention.

### DETAILED DESCRIPTION OF EXAMPLE EMBODIMENTS

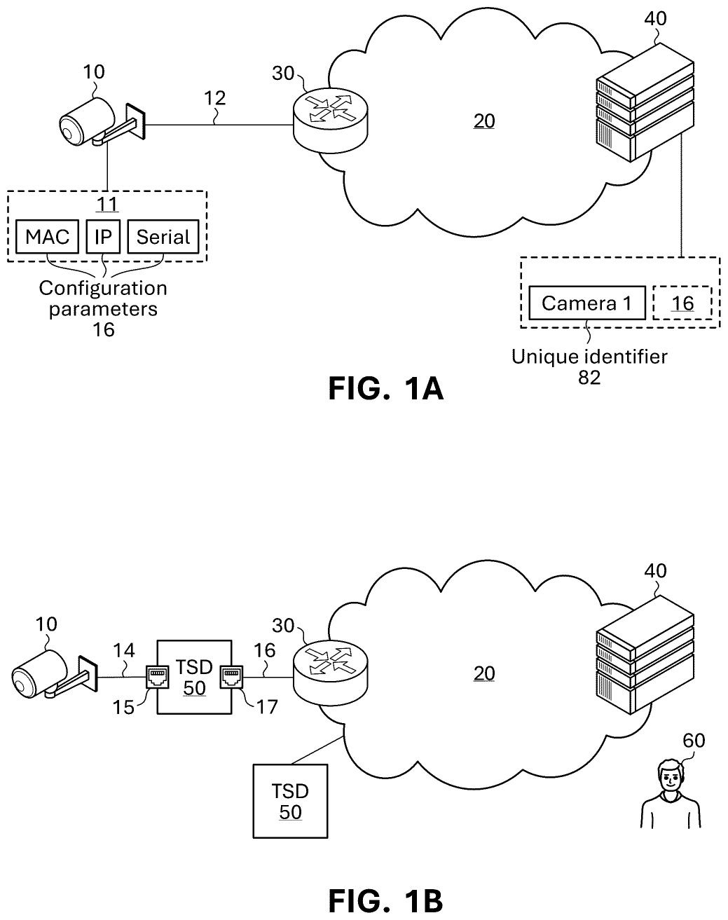

With reference to FIG. 1A, there is shown a network architecture prior to installation of a traffic sanitization device (shown as 50 in FIG. 1B). The network architecture includes a data network 20, which can include a private local area network (LAN) and/or part of the public internet, to name a few non-limiting possibilities. Various network elements are connected to and/or are part of the data network 20, including a server 40 and an edge device 30 (such as a router or switch).

With continued reference to FIG. 1A, the network architecture further includes an end device 10 connected to the edge device 30 via a communication link 12. In this non-limiting example, the end device 10 is a security or surveillance camera, although this need not be the case in other examples of implementation, where the end device 10 may be any sensor, network appliance or Internet-of-Things (IoT) device, to list a few non-limiting possibilities. In a non-limiting example embodiment, the communication link 12 can include an Ethernet or coaxial cable, although in other non-limiting examples, the communication link 12 may comprise any combination or wired or wireless links.

The camera 10 uses a set of camera configuration parameters 16 to identify itself and communicate over the data network 20. The camera configuration parameters 16 may be stored by the camera 10 (e.g., programmed in a memory 11 or other hardware component thereof). Some of the camera configuration parameters 16 are assigned to the camera 10 before it is connected to the data network 20 via the edge device 30. For example, such prior-assigned camera configuration parameters may include a serial number, media access control (MAC) address, global user identifier (GUID) (e.g., in the scope of a DHCP client) and/or fixed internet protocol (IP) address. Other ones of the camera configuration parameters are obtained by the camera 10 after connection to the edge device 30. Non-limiting examples of such later-obtained camera configuration parameters include a dynamic IP address and, in some cases, a port number. Other or additional camera configuration parameters can be used, such as but not limited to an IP network mask and an IP gateway identifier.

The camera 10 is assumed to have been registered (or “enrolled”) with the server 40, which signifies that the server 40 is aware of the camera configuration parameters 16 of the camera 10. To this end, and as shown in FIG. 1A, the server 40 maintains in its data memory 520 the camera configuration parameters 16 of the camera 10. In some embodiments, the server 40 also maintains in its data memory 520 a unique identifier 82 (in this case “CAMERA 1”) associated with the camera 10 so as to keep track of the identity of the camera to which the camera configuration parameters 16 belong.

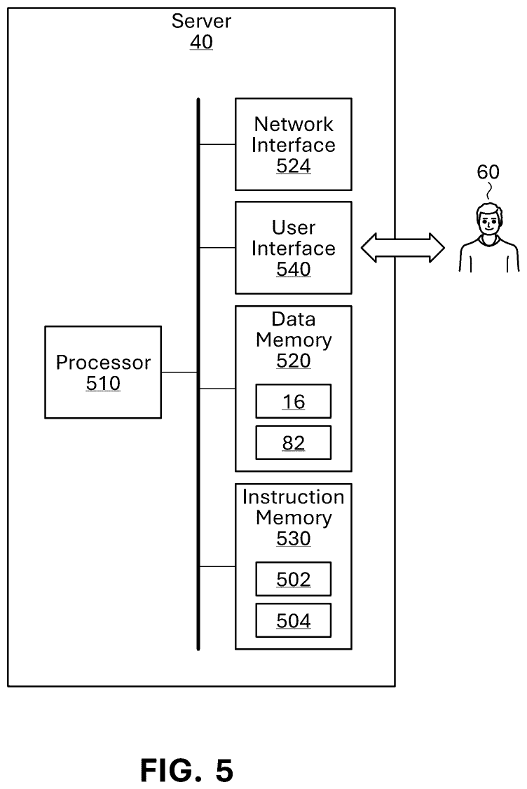

With reference to FIG. 5, the server 40 includes a computer-readable storage medium, which may include a data memory 520 and an instruction memory 530. The instruction memory 530 can comprise one or more tangible memory devices capable of storing program instructions for execution by a processor 510. The data memory 520 can comprise one or more tangible memory devices capable of storing data (e.g., 16, 82) for use by the processor 510 when executing the program instructions. Execution by the processor 510 of the instructions in the instruction memory 530 may result in the implementation of various processes.

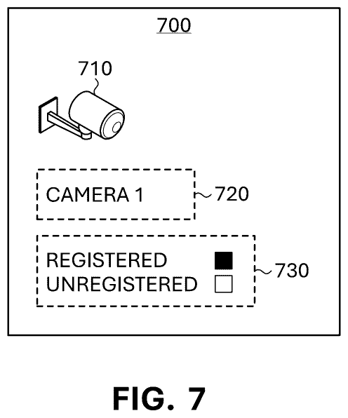

For example, the processor 510 may execute a set of instructions 502 in the instruction memory 530 to implement a “display process”, which results in a screen being displayed via the user interface 540. As shown in FIG. 7, the screen 700 may indicate to a user 60 that the camera 10 is registered with the server 40. Specifically, the screen 700 may present a camera icon 710, an area 720 that includes the unique identifier 82 of the camera 10 (in this case, “CAMERA 1”), and an indicator 730 that shows that the camera 10 is registered with the server 40 (e.g., by filling a box next to “registered” and leaving a box next to “unregistered” as unfilled). If the camera 10 were not registered (or enrolled), the indicator 730 would show that the camera 10 is unregistered (e.g., by filling the box next to “unregistered” and leaving the box next to “registered” as unfilled). Other examples and configurations of the screen 700 and the indicator 730 are of course possible.

The processor 510 may also execute a set of instructions 504 in the instruction memory 530 to carry out a “communication process” according to which the server 40 communicates over the data network 20 with the end device (e.g., the camera 10). According to this process, the server 40 is configured to detect the presence of the camera 10 and to communicate with the camera 10 (via the edge device 30). By virtue of the communication process, the server 40 may be configured to send commands towards the camera 10 and to receive packets containing data (e.g., video and/or audio), over the communication link 12.

As the camera 10 and the server 40 are connected via various links and network elements, a network stack (also referred to as a protocol stack) is used to facilitate communication. The network stack has a plurality of layers, which can be broadly categorized into media layers (low level) and host layers (high level). Once end-to-end communication is established between the camera 10 and the server 40, communication at the host layers may take place. However, in order to establish end-to-end communication between the camera 10 and the server 40 in the first place, communication at the media layers must take place. This may involve communication at various low-level layers, namely the physical layer, the data link layer and the network layer.

In a non-limiting example of implementation, the camera configuration parameters 16 include parameters (e.g., the camera's MAC address) that allow the camera 10 to communicate at the data link layer as well as parameters (e.g., the camera's IP address) that allow the camera 10 to communicate at the network layer. During registration or enrolment, the edge device 30 is configured to learn the camera configuration parameters 16 of the camera 10, store them in its internal routing tables and use them to accept future communications from the camera 10 and to relay future communications arriving from the data network 20 and destined for the camera 10. It is recalled that some of the camera configuration parameters are known to the camera 10 before it is connected to the edge device 30. These initial configuration parameters may be announced by the camera 10 to the edge device 30 over the communication link 12 (e.g., during a boot process), allowing the camera 10 to identify itself preliminarily and then to acquire the remaining camera configuration parameters thereafter.

Turning now to FIG. 1B, a traffic sanitization device (TSD) 50 is installed in-line between the camera 10 and the edge device 30. More specifically, the communication link 12 is separated into two parts, namely a first part 14 between the camera 10 and the TSD 50 and a second part 16 between the TSD 50 and the edge device 30. This can be achieved by disconnecting the communication link 12 (e.g., unplugging an Ethernet or coaxial cable) from the edge device 30 and instead connecting it to a first port 15 of the TSD 50 and by adding a second communication link (e.g., a second Ethernet or coaxial cable) between a second port 17 of the TSD 50 and the edge device 30 (to which the communication link 12 was formerly connected). In this way, the TSD 50 is disposed in-line between the camera 10 and the data network 20 via the edge device 30.

As a result of the in-line connection of the TSD 50, all communication from the server 40 to the camera 10, as well as all communication from the camera 10 to the server 40, passes through the TSD 50. Owing to its strategic position, the TSD 50 can carry out a traffic sanitization method on data traffic sent from the camera 10. However, considering that the camera 10 is assumed to have been previously registered with the server 40, installation of the TSD 50 as described above (e.g., by means of unplugging and re-plugging cables) requires the TSD 50 to carry out a “configuration process” so as to avoid having to change the already-acquired camera configuration parameters of the camera 10. This will be described below.

It is worth mentioning that the TSD 50 stores (e.g., in a non-transitory memory device of its own) a set of configuration parameters 56 (such as its own MAC address and its own IP address) allowing the TSD 50 to communicate with the camera 10 over the communication link 14. In cases where the data network 20 defines a subnet (e.g., a subset of acceptable IP addresses), the TSD 50 can be assigned any IP address in that subset (excluding, of course, the one used by the edge device 30) so as to allow the TSD 50 to successfully participate in communications as a node of the data network 20.

### Configuration Process of the TSD

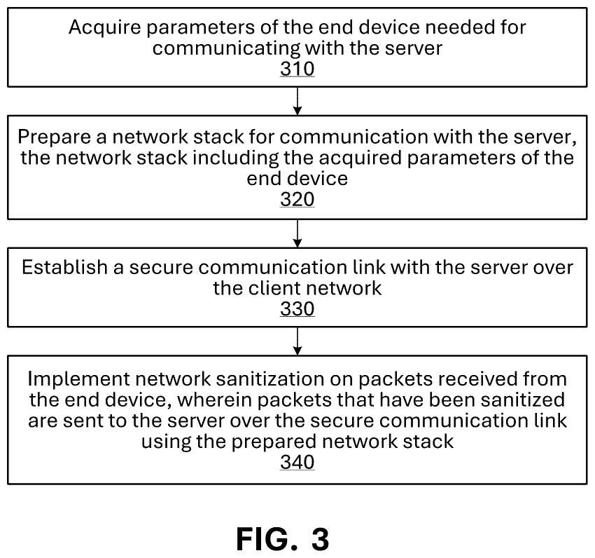

Turning now to the configuration process of the TSD 50, and with reference to FIG. 3, steps in a non-limiting example embodiment of the configuration process are now described. The configuration process may be encoded in a set of instructions 214 stored in non-transitory form in the instruction memory 216 and executed by the processor 220 of the TSD 50.

### 1^{st} Step

As a first step in the configuration process (step 310 in FIG. 3), the TSD 50 communicates with the camera 10 over the communication link 14 and discovers the camera configuration parameters 16 of the camera 10. It is recalled that the camera configuration parameters 16 were used by the camera 10 (before it was disconnected from the edge device 30 and connected to the TSD 50) for communicating with the edge device 30 at the media layer(s) of the network stack. Acquiring the camera configuration parameters 16 of the camera 10 can be done in at least two ways, referred to as Option A (involving a reboot of the camera 10) and Option B (without rebooting the camera 10).

In Option A, the camera 10 is rebooted, e.g., manually (by pressing a button or disconnecting and then reconnecting the power) or under remote command. Upon reboot, the camera 10 is configured to send one or more of its camera configuration parameters 16 over the communication link 14. Step 310 includes the TSD 50 intercepting any such camera configuration parameters sent by the camera 10 in response to being rebooted. Because they are intercepted by the TSD 50, the camera configuration parameters 16 are not transmitted over the communication link 16 and therefore do not reach the edge device 30 or the server 40. Instead, they are stored in the memory of the TSD 50. The camera configuration parameters 16 stored by the TSD 50 in its memory may include the serial number, MAC address, IP address and/or GUID of the camera 10 and/or other parameters.

The TSD 50 tries to intercept a “sufficient set” of camera configuration parameters. The “sufficient set” of camera configuration parameters includes those of the camera configuration parameters 16 that are required for the TSD 50 to successfully emulate the camera 10 to the edge device 30, i.e., to convince the edge device 30 that the device it is communicating with is the camera 10 (even though in reality the edge device 30 will be communicating with the TSD 50). In some examples of implementation, the “sufficient set” of camera configuration parameters includes at least the set consisting of (i) the MAC address of the camera 10 and (ii) the IP address of the camera 10. The TSD 50 is aware of what constitutes a sufficient set of camera configuration parameters; e.g., this information could be stored as a list of parameters or combinations of parameters in a memory of the TSD 50. Knowledge of the camera's MAC address may be particularly useful to allow the TSD 50 to automatically acquire the IP address that would be assigned to the camera 10 in the event of DHCP with automatic IP address assignment based on MAC address, with possible whitelisting.

Depending on what is sent by the camera 10 after being rebooted, the TSD 50 may successfully intercept a sufficient set of camera configuration parameters, in which case step 310 is complete. On the other hand, if the TSD 50 does not manage to intercept a sufficient set of camera configuration parameters further to rebooting of the camera 10 (e.g., if the TSD 50 collects a partial set of camera configuration parameters or no camera configuration parameters at all), then the TSD 50 may request or elicit the remaining camera configuration parameters from the camera 10 using a suitable protocol. For example, if the camera 10 is fully silent on boot, the TSD 50 could force a reply from the camera 10, e.g., by sending an ARP sweep, broadcasting a discovery message, etc.

It is noted that in some implementations, the camera 10 may possess a fixed IP address and the camera 10 may be configured to send out such IP address when booted. However, in other implementations, the camera 10 may obtain its IP address dynamically upon making a request. In that case, when booted, the camera 10 may send out a device-specific “ID” that is not the IP address (such as a MAC address, UUID, GUID, serial #, etc.). The device-specific ID would normally be destined for a DHCP server 80, which would dynamically assign an IP address to the device-specific ID. However, in the present non-limiting embodiment, the device-specific ID is intercepted by the TSD 50 and it is the TSD 50 that is configured to communicate with the DHCP server 80 to request an IP address on the basis of the device-specific ID. The TSD 50 therefore communicates with the DHCP server 80 via the edge device 30 over the data link layer, using the device-specific ID of the camera 10. The DHCP server 80 then assigns an IP address and the assigned IP address is returned (over the data link layer) to the TSD 50 via the edge device 30, which relays it to the camera 10 for use by the camera 10 in future communications.

Turning now to Option B, according to which the camera 10 is not rebooted, step 310 of the configuration process includes the TSD 50 passively listening in/eavesdropping on packets of video data issued by the camera 10. This can be referred to as the TSD entering/operating in “surveillance mode”. Communications issued by the camera 10 may, from time to time, include one or more of the camera configuration parameters 16. For example, certain IP packets (and Ethernet frames containing such packets) may include the IP address, MAC address and/or other camera configuration parameters. Once the TSD 50 has amassed the sufficient set of camera configuration parameters, the TSD 50 exits/ceases operation in “surveillance mode” and step 310 can be considered complete.

### 2^{nd} Step

The collection of a sufficient set of camera configuration parameters (either via Option A or Option B of step 310) will allow the TSD 50 to emulate the camera 10. Accordingly, a second step in the configuration process (step 320 in FIG. 3) may include the TSD 50 assembling a network stack (also referred to as a protocol stack) for communication with the server 40. The network stack 204 is stored in the data memory 206 of the TSD 50. The network stack 204 includes some or all of the camera configuration parameters discovered by the TSD 50 at step 310. As such, the TSD 50 is able to emulate the camera 10 by using the camera configuration parameters (MAC address, IP address, port, etc.) of the camera 10 in future communications to be sent by the TSD 50 to the edge device 30.

As a result, if the TSD 50 were to use the network stack 204 that includes the camera configuration parameters, the edge device 30 will see packets from the TSD 50 as if they were packets from the camera 10. In the opposite direction of communication, packets received from the data network 20 and destined for the camera 10 will be routed to the TSD 50 by the edge device 30, with the edge device believing that such packets are being routed to the camera 10.

### 3^{rd} Step

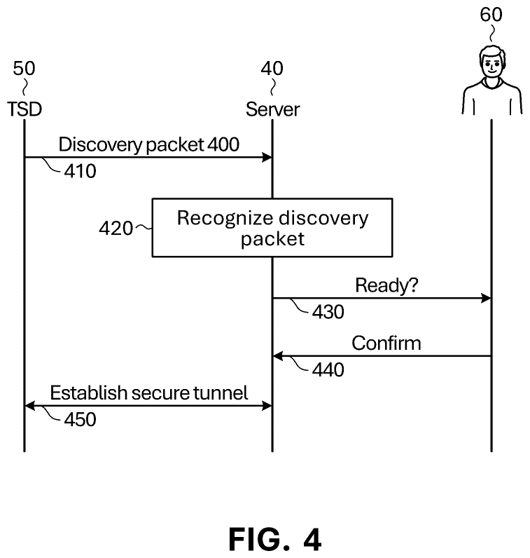

As a third step in the configuration process (step 330 in FIG. 3), the TSD 50 establishes a secure communication link with the server 40 over the data network 20. One way to accomplish this is now described with reference to the sequence of sub-steps illustrated in the signal flow diagram of FIG. 4.
At sub-step 410, the TSD 50 sends a discovery packet 400 to the server 40.
At sub-step 420, the server 40 recognizes the discovery packet 400.
At sub-step 430, the server 40 signals to the user 60 (e.g., via the user interface 540) that a device having the same camera configuration parameters as the camera 10 is ready to be re-registered, and requests instructions from the user 60.
At sub-step 440, the server 40 receives input from the user 60 (e.g., via the user interface 540) to proceed with re-registration of the camera 10. The server may thus re-register the camera 10 (which may have been previously registered before execution of the configuration process).
At sub-step 450, the server 40 establishes a secure tunnel with the TSD 50.

The secure tunnel between the server 40 and the TSD 50 can be established using a “trust-on-first-use” method involving only the endpoints (i.e., the TSD 50 and the server 40). Examples of a trust-on-first-use method include the use of protocols such as secure socket layer (SSL) and secure shell (SSH).

Alternatively, there may already be pre-established trust between the server 40 and the TSD 50, such as by way of a certificate installed with the aid of a trusted third-party device. In that case, the server 40 can rely on such certificate (or other indicia of pre-established trust) to establish a secure tunnel with the TSD 50. For example, certificate-based techniques may include mTLS (Mutual Transport Layer Security) and Yubikey, to name a few non-limiting possibilities.

In the implementation illustrated in FIG. 4, sub-step 450 occurs in response to the user input received at sub-step 440, which followed from the server 40's earlier recognition of a discovery packet from the TSD 50. However, in other implementations, no discovery packet is needed or employed. In that case, sub-steps 410-440 do not apply, and the server 40 proceeds directly to sub-step 450 and establishes a secure tunnel with the TSD 50. Since it will not be in receipt of a discovery packet from the TSD 50, the server 40 needs to “guess” when it is time to establish a secure tunnel with the TSD 50, or otherwise rely on go-ahead instructions from the user 60.

The aforementioned sub-steps involve communications between the TSD 50 and the server 40. For the purposes of these communications, and in a first embodiment, the TSD 50 can use the network stack 204 that includes the camera configuration parameters 10, whereby the TSD 50 emulates the camera 10. In a second embodiment, the TSD 50 can create/prepare a second network stack (not shown) that does not include the camera configuration parameters 16 of the camera 10 but rather includes configuration parameters (e.g., MAC address, IP address) that are unique to the TSD 50. In such a second embodiment, the second network stack is used by the TSD 50 to establish the secure tunnel with the server 40. In that case, the two distinct network stacks (the network stack 204 and the second network stack) are linked to the same physical network interface controller (NIC) on the TSD 50. This results in two devices being “seen” by the data network; for example, the TSD 50 could be reachable from the server 40 at a separate webpage.

### 4^{th} Step

As a fourth step of the configuration process (step 340 in FIG. 3), the TSD 50 implements traffic sanitization on packets received from the camera 10, and packets that are sanitized in this way are sent to the server 40 over the secure communication link using the network stack 204 assembled at step 320 (i.e., the network stack that includes the camera configuration parameters 16).

As part of its sanitization functionality, TSD 50 can block incoming packets from the camera 10 (which may include video and/or audio), administer a test on the received packets for security purposes and then re-transmit them towards the server 40 if the test is passed. In the other direction of communication, the TSD 50 passes packets from the server 40 through to the camera 10, without necessarily blocking or considering their contents.

It is noted that the aforementioned approach allows the insertion of a traffic sanitization device in the communication path between a camera and a server where the camera has been enrolled, for the purposes of sanitizing the camera traffic sent towards the server, and yet for the camera to continue using its original camera configuration parameters when communicating with the server. This eliminates the complexity of dealing with new camera configuration parameters that might otherwise be allocated to the camera upon insertion of a conventional intermediate device in the aforementioned communication path between the camera and the server.

In summary, the TSD 50 carries out a method whose steps are illustrated in FIG. 3. Specifically, at step 310, the TSD 50 acquires configuration parameters of the end device 10 (such as a security camera) needed for communicating with the server 40. At step 320, the TSD 50 creates/prepares a network stack 204 for communication with the server 40, the network stack including the configuration parameters of the end device 10 acquired at step 310. At step 330, the TSD 50 establishes a secure communication link with the server 40 over the data network 20. Finally, at step 340, the TSD 50 implements traffic sanitization on packets received from the end device 10. In this way, packets from the end device 10 that have been sanitized by the TSD 50 at step 340 are sent to the server 40 over the secure communication link using the network stack 204 assembled at step 230.

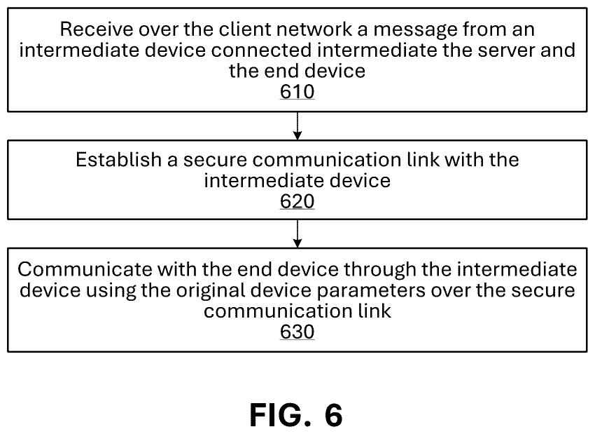

From the perspective of the server 40, the processor 510 may execute a set of instructions 504 in the instruction memory 530 to carry out a method for communicating over a data network with an end device 10 (e.g., a security camera) configured to have certain original device configuration parameters. As shown in FIG. 6, this method includes receiving over the data network a message from an intermediate device (e.g., the TSD 50) connected intermediate the server and the end device (step 610), establishing a secure communication link with the intermediate device (620); and communicating with the end device through the device using the original device configuration parameters over the secure communication link (step 630). This can render secure a previously registered end device (e.g., security) camera without having to re-configure its configuration parameters.

### Multi-Camera Scenario

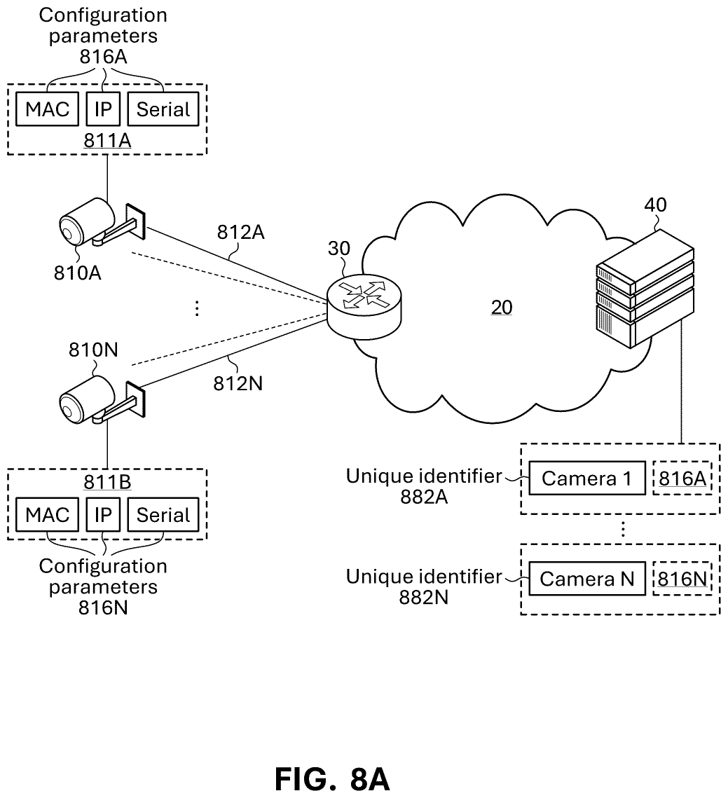

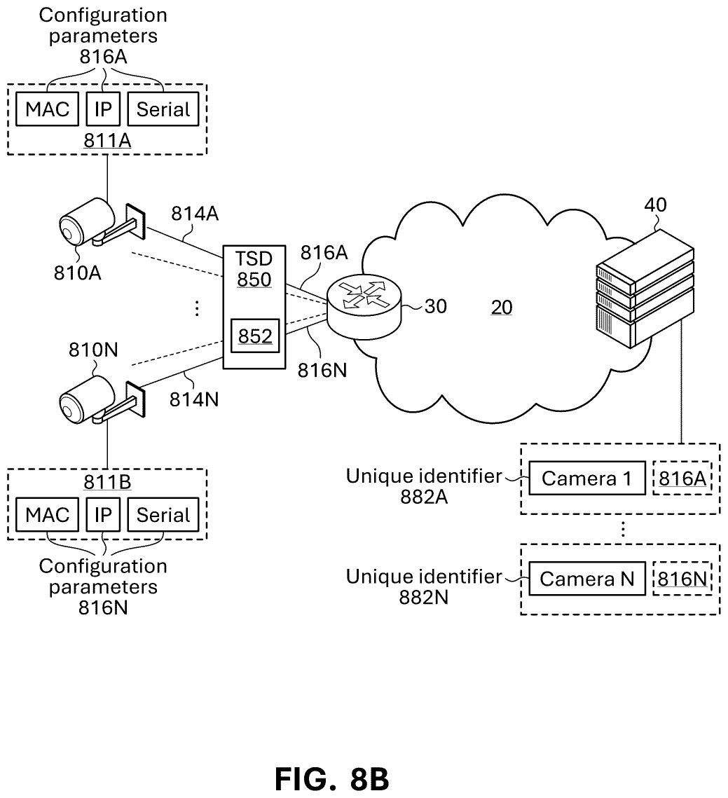

Those skilled in the art will also appreciate that a multi-camera scenario is also possible. Accordingly, and with reference to FIG. 8A, there is shown a network architecture prior to installation of a traffic sanitization device (shown as 850 in FIG. 8B), the network architecture including a plurality of end devices 810A, . . . , 810N connected to the edge device 30 via respective communication links 812A, . . . , 812N. In this non-limiting example, the end devices 810A, . . . , 810N are security cameras, although this need not be the case in other examples of implementation, where each of the end devices 810A, . . . , 810N may be any sensor, network appliance or Internet-of-Things (IoT) device, to list a few non-limiting possibilities.

Each of the cameras 810A, . . . , 810N uses a respective set of camera configuration parameters 816A, . . . , 816N to identify itself and communicate over the data network 20. The camera configuration parameters 816A, . . . , 816N may be stored in a respective memory 811A, . . . , 811N of the respective camera. Some of the camera configuration parameters 816A, . . . , 816N are assigned to the respective camera 810A, . . . , 810N before it is connected to the data network 20 via the edge device 30. For example, such prior-assigned camera configuration parameters may include a serial number, media access control (MAC) address, global user identifier (GUID) or fixed internet protocol (IP) address. Other ones of the camera configuration parameters are obtained by the cameras 810, . . . , 810N after connection to the edge device 30. Non-limiting examples of such later-obtained camera configuration parameters include a dynamic IP address and a port number. Other or additional camera configuration parameters can be used.

The cameras 810A, . . . , 810N are assumed to have been registered (or “enrolled”) with the server 40, which signifies that the server 40 is aware of the camera configuration parameters 816A, . . . , 816N of each respective camera 810A, . . . , 810N. To this end, the server 40 maintains in its data memory 520 the camera configuration parameters 816A, . . . , 816N of each respective camera 810A, . . . , 810N. In some embodiments, the server 40 also maintains in its data memory 520 a set of unique identifiers 882A, . . . , 882N (in this case “CAMERA 1”, . . . , “CAMERA N”) respectively associated with the cameras 810A, . . . 810N so as to keep track of the identity of the camera to which the camera configuration parameters 816A, . . . , 816N belong.

As the cameras 810A, . . . , 810N and the server 40 are connected via various links and network elements, a network stack (also referred to as a protocol stack) is used to facilitate communication. The network stack has a plurality of layers, which can be broadly categorized into media layers (low level) and host layers (high level). Once end-to-end communication is established between each of the cameras 810A, . . . , 810N and the server 40, communication at the host layers may take place. However, in order to establish end-to-end communication between each of the cameras 810A, . . . , 810N and the server 40 in the first place, communication at the media layers must take place. This may involve communication at various low-level layers, namely the physical layer, the data link layer and the network layer.

In a non-limiting example of implementation, the camera configuration parameters 816i for a given camera 810i (i=A, . . . , N) include parameters (e.g., the camera's MAC address) that allow the camera 810i to communicate at the data link layer as well as parameters (e.g., the camera's IP address) that allow the camera 810i to communicate at the network layer. During registration or enrolment, the edge device 30 is configured to learn the camera configuration parameters 816i of the camera 810i, store them in its internal routing tables and use them to accept future communications from the camera 810i and to relay future communications arriving from the data network 20 and destined for the camera 810i. It is recalled that some of the camera configuration parameters are known to the camera 810i before it is connected to the edge device 30. These initial configuration parameters may be announced by the camera 810i to the edge device 30 over the communication link 812i (e.g., during a boot process), allowing the camera 810i to identify itself preliminarily and then to acquire the remaining camera configuration parameters thereafter.

Turning now to FIG. 8B, a traffic sanitization device (TSD) 850 is installed between the cameras 810A, . . . , 810N and the edge device 30. More specifically, each of the communication links 812A, . . . , 812N is separated into two parts, namely a respective first part 814A, . . . , 814N between the respective camera 810A, . . . , 810N and the TSD 850 and a respective second part 816A, . . . , 816N between the TSD 50 and the edge device 30. This can be achieved by disconnecting the respective communication link 812A, 812N (e.g., unplugging an Ethernet or coaxial cable) from the edge device 30 and instead connecting it to a respective one of a plurality of first ports of the TSD 850 and by adding a second communication link (e.g., a second Ethernet or coaxial cable) between a respective one of a plurality of second ports of the TSD 850 and the edge device 30 (to which the respective communication link 812A, . . . , 812N was formerly connected). In this way, the TSD 850 is disposed in-line between the cameras 810A, . . . , 810N and the data network 20 via the edge device 30.

As a result of the in-line connection of the TSD 850, all communication from the server 40 to the cameras 810A, . . . , 810N, as well as all communication from the cameras 810A, . . . , 810N to the server 40, passes through the TSD 850. Owing to its strategic position, the TSD 850 can carry out a traffic sanitization method on data traffic sent from the cameras 810A, . . . , 810N. However, considering that the cameras 810A, . . . , 810N are assumed to have been previously registered with the server 40, installation of the TSD 850 as described above (e.g., by means of unplugging and re-plugging cables) requires the TSD 850 to carry out a “configuration process” so as to avoid having to change the already-acquired camera configuration parameters of the cameras 810A, . . . , 810N. This will be described below.

It is worth mentioning that the TSD 850 stores (e.g., in a non-transitory memory device 852 of its own) a set of configuration parameters (such as its own MAC address and its own IP address) allowing the TSD 850 to communicate with the cameras 810A, . . . , 810N over the respective communication links 814A, . . . , 814N. In cases where the data network 20 defines a subnet (e.g., a subset of acceptable IP addresses), the TSD 850 can be assigned any IP address in that subset (excluding, of course, the one used by the edge device 30) so as to allow the TSD 850 to successfully participate in communications as a node of the data network 20.

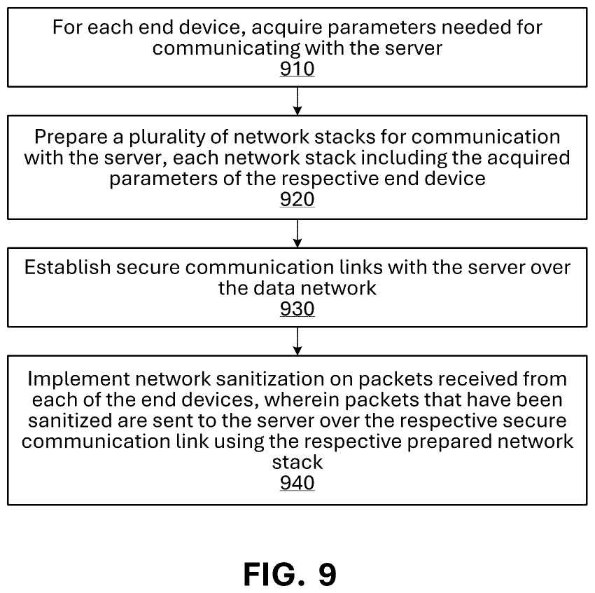

In the multi-camera scenario, the TSD 850 is configured to carry out a method whose steps are illustrated in FIG. 9. Specifically, at step 910, the TSD 850 acquires, for each end device 810i (i=A, . . . , N), configuration parameters of the end device 810i needed for communicating with the server 40. At step 920, the TSD 850 creates/prepares a plurality of network stacks for communication with the server 40, each network stack including the configuration parameters of a respective one of the end devices 810A, 810N acquired at step 910. At step 930, the TSD 850 establishes secure communication with the server 40 over the data network 20. This an involve creating a plurality of secure communication links (e.g., HTTPS connection), each one associated with the IP address (or other configuration parameter) of a respective one of the end devices 81A, . . . , 810N. Communications over the secure communication links occur over the network stacks created at step 920. Finally, at step 940, the TSD 850 implements traffic sanitization on packets received from each of the end devices 810A, . . . , 810N. In this way, packets from each of the end devices 810A, . . . , 810N that have been sanitized by the TSD 850 are sent to the server 40 over the secure communication link using the network stack 204 assembled at step 930.

With reference to FIG. 5, it will be appreciated that in some examples of implementation, the computer-readable storage medium 520, 530 of the server 40 may include, without limitation, an electronic storage device, a magnetic storage device, an optical storage device, an electromagnetic storage device, a semiconductor storage device, or any suitable combination of the foregoing. A non-exhaustive list of more specific examples of either or both of the computer-readable storage medium 520, 530 includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, does not include transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Program instructions can be downloaded to the computer-readable storage medium 530 from an external computer or external storage device via the data network 20. A network adapter card or network interface 524 receives program instructions over the data network 20 and forwards them to the computer-readable storage medium 530 for storage and execution by the processor 510. Execution of the program instructions by the processor 530 results in the server 40 carrying out processes such as those described above and other processes (including an operating system, for example).

A user interface 540 is also connected to the processor 510 and may include various input and/or output devices, as well as program instructions that interact with the various input and/or output devices so as to elicit input from the user 60 and provide output to the user 60 via the input and/or output devices. The user interface 540 may be a graphical user interface for interfacing with the user 60. A bus architecture may interconnect the user interface 540, the processor 510, the memory 520, 530 and the network interface 524. The user interface 540 may also be part of a user device that is itself connected to the server 40 by another communication link.

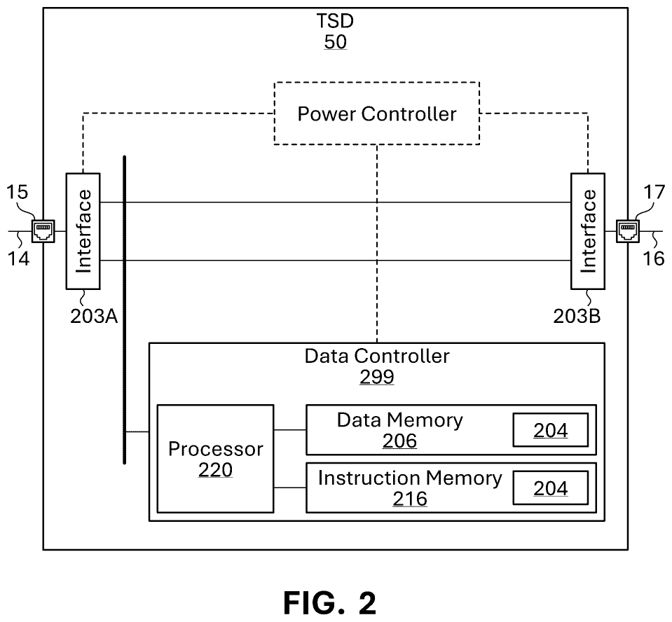

Those of skill in the art will also appreciate that the TSD 50 in FIG. 2 includes a data controller 299 connected to a first interface 203A and a second interface 203B via (in this case) a bus. The interfaces 203A, 203B can be hybrids. A bidirectional link connects the first interface 203A to the first port 15. A bidirectional link connects the second interface 203B to the second port 17. Two unidirectional links connect the first interface 203A to the data controller 299. Similarly, two unidirectional links connect the second interface 203B to the data controller 299. In some embodiments, a power controller supplies power to the data controller 299 and to the two interfaces 203A, 203B.

The data controller 299 includes a computer-readable storage medium 206, 216, which can be one or more tangible devices capable of storing program instructions (e.g., 214) and data (e.g., 204) for use by a processor 220. The computer-readable storage medium 206, 216 may be, for example, but is not limited to, an electronic storage device, a magnetic storage device, an optical storage device, an electromagnetic storage device, a semiconductor storage device, or any suitable combination of the foregoing. A non-exhaustive list of more specific examples of either or both of the computer-readable storage medium 206, 216 includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, does not include transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Execution of the program instructions in the memory 216 by the processor 220 results in the data controller 299/TSD 50 carrying out processes such as those described above and other processes.

The various program instructions referred to above may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In some embodiments, electronic circuitry including, for example, programmable logic circuitry, field-programmable gate arrays (FPGA), or programmable logic arrays (PLA) may execute the program instructions by utilizing state information to personalize the electronic circuitry, in order to carry out aspects of the present disclosure.

Aspects of the present disclosure are described herein with reference to flowcharts and block diagrams of methods and apparatus (systems), according to various embodiments. It will be understood that each block of the flowcharts and block diagrams, and combinations of such blocks, can be implemented by execution of the program instructions. Namely, the program instructions, which are read and processed by the processor 530 of the computing apparatus 510, direct the processor 530 to implement the functions/acts specified in the flowchart and/or block diagram block or blocks. It will also be noted that each block of the flowcharts and/or block diagrams, and combinations of such blocks, can also be implemented by special purpose hardware-based systems that perform the specified functions or acts or carry out combinations of special purpose hardware and computer instructions.

The flowcharts and block diagrams illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the drawings. For example, two blocks shown in succession may, in fact, be executed substantially concurrently, or the blocks may sometimes be executed in the reverse order, depending upon the functionality involved.

The descriptions of the various embodiments of the present disclosure have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It should be appreciated that throughout the specification, discussions utilizing terms such as “processing”, “computing”, “calculating”, “determining”, “analyzing” or the like, can refer to the action and/or processes of a computer or computing system, or similar electronic computing device, that manipulate and/or transform data represented as physical, such as electronic, quantities into other data similarly represented as physical quantities.

As used herein, unless otherwise specified, the use of the ordinal adjectives “first”, “second”, “third”, etc., to describe a common object or step, merely indicate that different instances of like objects or steps are being referred to, and are not intended to imply that the objects or steps so described must be in a given sequence, either temporally, spatially, in ranking, or in any other manner.

It is noted that various individual features may be described only in the context of one embodiment. The particular choice for description herein with regard to a single embodiment is not to be taken as a limitation that the particular feature is only applicable to the embodiment in which it is described. Various features described in the context of one embodiment described herein may be equally applicable to, additive, or interchangeable with other embodiments described herein, and in various combinations, groupings or arrangements. In particular, use of a single reference numeral herein to illustrate, define, or describe a particular feature does not mean that the feature cannot be associated or equated to another feature in another drawing figure or description.

Also, when the phrase “at least one of C and D” is used, this phrase is intended to and is hereby defined as a choice of C or D or both C and D, which is similar to the phrase “and/or”. Where more than two variables are present in such a phrase, this phrase is hereby defined as including only one of the variables, any one of the variables, any combination of any of the variables, and all of the variables.

The foregoing description and accompanying drawings illustrate the principles and modes of operation of certain embodiments. However, these embodiments should not be considered limiting. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention.

What is claimed is:

1. A method for operating a traffic sanitization device connectable intermediate an end device and a data network communicatively coupled to a server, the method comprising:
acquiring configuration parameters of the end device required for communicating with the server;
creating a network stack for communication with the server, the network stack including the acquired configuration parameters of the end device;
establishing a secure communication link with the server over the data network; and
implementing traffic sanitization on packets received from the end device, wherein packets that have been sanitized are sent to the server over the secure communication link using the created network stack.

2. The method defined in claim 1, wherein the configuration parameters were previously used by the end device for communication with the server.

3. The method defined in claim 1, wherein acquiring the configuration parameters includes intercepting the configuration parameters sent from the end device.

4. The method defined in claim 3, further comprising causing the end device to send the configuration parameters.

5. The method defined in claim 4, wherein causing the end device to send the configuration parameters comprises rebooting the end device.

6. The method defined in claim 5, wherein causing the end device to send the configuration parameters comprises sending a request to the end device.

7. The method defined in claim 1, wherein the configuration parameters comprises a set of parameters required by the traffic sanitization device to emulate the end device over the data network.

8. The method defined in claim 7, further comprising identifying the set of parameters by consulting a list of parameters stored in a memory of the traffic sanitization device.

9. The method defined in claim 3, wherein the end device is a surveillance camera and wherein the intercepting comprises passively listening in on packets of video data sent by the surveillance camera.

10. The method defined in claim 1, further comprising sending a discovery packet to the server to cause the server to signal to a user of the server that a device having the configuration parameters is ready to be re-registered.

11. The method defined in claim 1, wherein the secure communication link is established based on a “trust-on-first-use” method.

12. The method defined in claim 1, wherein the secure communication link is based on a pre-established trust between the traffic sanitization device and the server.

13. The method defined in claim 1, wherein implementing traffic sanitization on packets received from the end device comprises blocking the received packets, administering a test to the received packets for security purposes and re-transmitting the received packets towards the server if the test is passed.

14. The method defined in claim 1, wherein the secure communication link is established by the traffic sanitization device communicating using the created network stack.

15. The method defined in claim 1, further comprising creating a second network stack including configuration parameters of the traffic sanitization device, wherein the secure communication link is established by the traffic sanitization device using the second network stack.

16. The method defined in claim 1, wherein the end device is a first end device, and wherein traffic sanitization device is connectable intermediate a second end device and the data network communicatively coupled to the server, the method further comprising:
acquiring second configuration parameters of the second end device required for communicating with the server;
creating a second network stack for communication with the server, the second network stack including the acquired second configuration parameters;
establishing a second secure communication link with the server over the data network; and
implementing traffic sanitization on packets received from the second end device, wherein packets received from the second end device and that have been sanitized are sent to the server over the second secure communication link using the second network stack.

17. A non-transitory computer-readable medium comprising computer-readable instructions which, when read by a processor of a traffic sanitization device connectable intermediate an end device and a data network communicatively coupled to a server, causes the traffic sanitization device to carry out the method of claim 1.

18. A traffic sanitization device connectable intermediate an end device and a data network communicatively coupled to a server, comprising:
a memory storing computer-readable instructions; and
a processor configured to read the instructions in the memory so as to carry out a method that comprises:
acquiring configuration parameters of the end device required for communicating with the server;
creating a network stack for communication with the server, the network stack including the acquired configuration parameters of the end device;
establishing a secure communication link with the server over the data network; and
implementing traffic sanitization on packets received from the end device, wherein packets that have been sanitized are sent to the server over the secure communication link using the created network stack.

19. A method for operating a server connectable over a data network to an end device configured to have a set of device configuration parameters, the method comprising:
receiving over the data network a message from an intermediate device connected intermediate the server and the end device;
establishing a secure communication link with the intermediate device; and
communicating with the end device through the intermediate device over the secure communication link using a network stack that includes at least some of the device configuration parameters.

20. The method defined in claim 19, further comprising, prior to said receiving, registering the device with the server.

21. The method defined in claim 20, further comprising:
receiving a packet from the intermediate device;
signaling that a device having said configuration parameters is ready to be re-registered;
receiving input to proceed with re-registration of the end device.

22. The method defined in claim 21, wherein the packet is a discovery packet, the method further comprising recognizing the packet as a discovery packet, wherein the signaling is performed in response to recognizing the packet as a discovery packet.

23. The method defined in claim 21, wherein the signaling and receiving are carried out with respect to a user of the server.

24. The method defined in claim 21, wherein the secure communication link is established after said receiving input.

25. The method defined in claim 19, further comprising determining that it is time to establish a secure communication link and wherein the secure communication link is established in response to determining that it is time to establish a secure communication link.

26. The method defined in claim 19, wherein the secure communication link is established based on a “trust-on-first-use” method.

27. The method defined in claim 19, wherein the secure communication link is based on a pre-established trust between the server and the intermediate device.

28. The method defined in claim 19, wherein the network stack was previously used by the server to communicate with the end device.

29. The method defined in claim 19, wherein the network stack is a second network stack different from a first network stack previously used by the server to communicate with the end device.

30. The method defined in claim 19, the end device being a first end device, the server coupled over the data network with a second end device configured to have a second set of device configuration parameters, the method further comprising:
receiving over the data network a second message from the intermediate device, the intermediate device connected intermediate the server and the second end device;
establishing a second secure communication link with the intermediate device; and
communicating with the second end device through the intermediate device over the second secure communication link using a second network stack that includes at least some of the second set of device configuration parameters.

31. A non-transitory computer-readable medium comprising computer-readable instructions which, when read by a processor of a server connectable over a data network to an end device configured to have a set of device configuration parameters, causes the server to carry out the method of claim 19.

32. A server connectable over a data network to an end device configured to have a set of device configuration parameters, the server comprising:
a memory storing computer-readable instructions; and
a processor configured to read the instructions in the memory so as to carry out a method that comprises:
receiving over the data network a message from an intermediate device connected intermediate the server and the end device;
establishing a secure communication link with the intermediate device; and
communicating with the end device through the intermediate device over the secure communication link using a network stack that includes at least some of the device configuration parameters.
